(19) United States
(12) Patent Application Publication
(10) Pub. No.: US 2013/0172104 A1
(43) Pub. Date: Jul. 4, 2013

(54) Ionomer/Polyamide Alloy For Golf Balls

(71) Applicant: Thomas J. Kennedy, III, Wilbraham, MA (US)

(72) Inventor: Thomas J. Kennedy, III, Wilbraham, MA (US)

(73) Assignee: NIKE, INC., Beaverton, OR (US)

(21) Appl. No.: 13/341,544

(22) Filed: Dec. 30, 2011

(51) Int. Cl. A63B 37/00; C08L 77/00

(52) U.S. Cl. 473/371; 525/179

(57) ABSTRACT

A high-hardness, durable golf ball layer is formed from an ionomer/polyamide alloy. The polyamide is produced, in part, from renewable resources.

### BACKGROUND

The present disclosure relates generally to golf balls comprising an ionomer/polyamide alloy. In particular, the disclosure relates to golf balls comprising an ionomer/polyamide alloy that includes components derived from renewable resources. Thus, the golf balls are environmentally friendly, as the manufacture of the golf balls requires lesser quantities of petroleum products and other non-renewable resources.

Golf balls are important sporting goods that have changed with changes in technology. For example, balls were first made of wood, and then by stuffing boiled, softened feathers into a leather sack. The sack typically was painted white, and would tighten upon drying. However, because the feather ball tended to absorb moisture and to split, many balls were required to play a round. Also, these feather balls were expensive as compared with wooden balls.

Both feather and wooden balls were in use until the gutta percha ball was made. The gutta percha ball was relatively inexpensive and easily manufactured. Also, the gutta percha ball was fairly durable, as compared with the feather ball, performed well because the surface could easily be roughened to improve flight characteristics, and so became popular. However, the ball exhibited a tendency to break up in flight.

Golf balls comprising other elastic materials then were developed. For example, a golf ball having a rubber core and an elastic thread wound tightly around the core was developed. The winding was covered with gutta percha at first, but later with balata. However, balata-covered golf balls often are damaged by players who are less skilled at striking the ball. Thus, tougher covers were developed, including in particular covers comprising a Surlyn® compound or a polyurethane compound.

This quest for a more durable golf ball has provided some performance benefits. Cover layers comprising ionomeric compositions, such as Surlyn®, and hard polyurethane provide desirable performance properties and characteristics. For example, such golf balls exhibit low spin, high launch angle, and high speed when struck by driver-type clubs. When struck with an iron or wedge club, such balls exhibit good backspin, launch angle, and speed.

However, use of ever-harder cover layers leads to golf balls that lack durability. Hard covers become susceptible to cracking and crazing and sometimes exhibit a limited resistance to scuffing and other damage caused by both perfect hits of skilled players and miss-hits that golfers having less skill are likely to inflict upon the golf ball.

The interior structure of the golf ball also has advanced, with plastics and polymeric materials having properties and characteristics appropriate for manufacture of high-quality, high-performance, affordable golf balls. In particular, polymeric materials having properties and characteristics appropriate for golf ball manufacture have been developed. Such polymeric materials include polyurethanes and ionomeric materials, including highly neutralized acid polymers. Blended materials also are used to manufacture other products.

Thus, golf balls have come to require a significant amount of petroleum-based and other non-renewable resources. Therefore, there exists a need in the art for a high-performance golf ball that includes components that are from renewable resources. Such a golf ball is both environmentally friendly and exhibits high performance.

### SUMMARY

The disclosure is directed to a golf ball comprising an ionomer/polyamide alloy. In particular, the ionomer/polyamide alloy is used in the cover to provide a golf ball that has desired performance properties and characteristics and is durable. A component of the polyamide is derived from a renewable source. Therefore, such a golf ball exhibits high performance, is durable, and is environmentally friendly.

In one aspect, the disclosure provides a golf ball comprising an ionomer/polyamide alloy in the cover, thus providing a cover that yields a high performance golf ball that is durable.

In other aspects, the disclosure provides golf balls comprising an ionomer/polyamide alloy in an inner layer, such as an outer core layer, a mantle layer, or an inner cover layer.

In another aspect, the disclosure relates to golf balls comprising an ionomer/polyamide alloy that includes components that are derived from renewable resources.

In still another aspect, the disclosure relates to golf balls that are environmentally friendly, as the manufacture of the golf balls requires lesser quantities of petroleum products and other non-renewable resources.

In yet another aspect, the disclosure relates to a method for manufacturing a golf ball having a cover layer comprising an ionomer/polyamide alloy.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The invention can be better understood with reference to the following drawing and description. The components in the figure are not necessarily to scale, emphasis instead being placed upon illustrating the principles of the invention. Moreover, in the figure, like reference numerals designate corresponding parts throughout the different views.

FIG. 1 shows a representative four-piece golf ball in accordance with this disclosure, the golf ball having an inner core layer, an outer core layer, an inner cover layer, and an outer cover layer.

FIG. 2 is a schematic of a golf ball with a cover having the highest scuff resistance or a scuff score of “1”.

FIG. 3 is an enlarged schematic of the golf ball of FIG. 2.

FIG. 4 is a schematic of a golf ball with a cover having the lowest scuff resistance or a scuff score of “5”.

FIG. 5 is a schematic of the golf ball of FIG. 4 but at a different angle.

### DETAILED DESCRIPTION

The disclosure is directed to a golf ball comprising an ionomer/polyamide alloy. In particular, the ionomer/polyamide alloy is used in the cover to provide a golf ball that has desired performance properties and characteristics and is durable. A component that forms a significant portion of the polyamide is derived from a renewable source. Therefore, such a golf ball exhibits high performance, is durable, and is environmentally friendly.

Skilled practitioners recognize that golf balls can be one piece or multiple pieces, or layers, and that the pieces may be made up of many compositions. These pieces, or layers, form a core and a cover for the core, with the cover substantially enclosing and surrounding the core. Thus, the core is at the center of the ball, and the outer cover layer forms the outer surface. A golf ball that is one piece typically is known simply as a one-piece ball, as the core and the cover are the same composition of matter.

Both the core and the cover may be formed of multiple pieces. For example, a two-piece ball typically will be characterized as having a core and a cover enclosing the core. A three-piece ball may be characterized as having an inner core layer, an outer core layer surrounding the inner core layer, and a cover layer. Alternatively, such a three-piece ball may be characterized as having a core, an inner cover layer surrounding the core, and an outer cover layer surrounding the inner cover layer. The number of pieces used to form a ball is unlimited, but typically does not exceed seven.

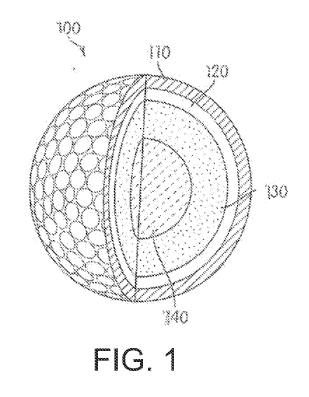

FIG. 1 shows a golf ball 100 made in accordance with the method of the present invention. Golf ball 100 includes an inner core layer 140, an outer core layer 130 substantially surrounding inner core layer 140, an inner cover layer 120 substantially surrounding outer core layer 130, and an outer cover layer 110 substantially surrounding inner cover layer 120.

The various layers also may have other names. Layers that are not the inner core or outer cover may be generically labelled as intermediate layers. Another convention is to label a layer between a cover layer and a core layer as a mantle layer. Often, a mantle layer is a thin layer between an outer core layer and a cover layer. Many names are used to identify the layers of a multi-piece golf ball.

The names ascribed to many intermediate layers of a golf ball may vary. However, it is not the name of the layer but the composition of matter used to make the layer that controls the properties and characteristics of the golf ball. The number of layers can vary and the layers, other than the outer cover layer, can be made from any composition that has the properties and characteristics suitable for manufacture of that layer of a golf ball. As the skilled practitioner appreciates, each layer has a role in determination of the performance properties and characteristics of the golf ball. Therefore, it is necessary to select a composition that exhibits the requisite properties and characteristics.

For example, the core is known as “the engine” of the golf ball. Therefore, the core typically is made from resilient materials that impart energy to the ball. The outer cover layer not only forms the striking surface of the ball and protects the ball from damage, but also affects the properties and characteristics, particularly flight characteristics, of the golf ball. Particularly with a two-piece golf ball, the cover exerts significant influence on the properties and characteristics of the ball. For example, a hard cover allows for low spin rate and high launch angle. Thus, the outer cover layer must both be durable and impart the desired properties and characteristics.

The inner core layer, which forms the center of a golf ball, typically is made from metal (which may be hollow) or rubber, whether natural or synthetic, for example, or may include a fluid-filled container. Also, other synthetic materials, particularly polymers such as ionomers, polyurethane, polyester, polyether, and polyacrylates, may be used. The compounds from which many synthetic rubbers are made, such as 1,4-butadiene and other unsaturated hydrocarbons, such as isoprene, are derived from petroleum feedstocks.

Cover layers typically are rubbers or polymers, particularly ionomers and polyurethanes. Cover layers, and particularly the outer cover layer, are selected to be hard, durable materials. Such materials include ionomers, such as the Surlyn® products from duPont, and polyurethane. Outer cover layers often are made from these materials. Ionomers are commercially available from a number of sources, including duPont (Surlyn® products) and ExxonMobil (lotek®) products. Polyurethane also is freely available from many commercial sources.

These ionomer polymers comprise an acid component that is partially neutralized with a cation, typically a metal, an alkali metal, or an alkaline earth metal cation. The cation, often selected from magnesium, sodium, zinc, and lithium, provides the ionomer polymer with both covalent and ionic crosslinks while forming a tough and durable polymer.

However, very hard materials used to form outer cover layers suffer from reduced durability of the golf ball cover. This phenomenon is noticed particularly with ionomer outer cover layers. Further, these ionomers are made from an ethylenically unsaturated compound (C₁-C₈ α-olefins), typically ethylene; an α,β-unsaturated carboxylic acid, typically (meth)acrylic acid; and, perhaps, an alkyl acrylate. Each of these compounds is a petroleum-based product.

Thus, it can be seen that a significant fraction of a golf ball, if not the entirety of the golf ball, typically is made from non-renewable, petroleum-based compounds. This circumstance is not sensitive to environmental concerns.

The inventor has discovered that a polyamide can be incorporated into an ionomer outer cover layer to yield a golf ball that is both hard and durable. The golf ball including this polyamide is as hard as, if not harder than, and has flight properties and characteristics comparable to, if not better than, flight properties and characteristics of golf balls having ionomer outer covers. The golf ball including polyamide in the outer cover layer also has a more durable cover.

The inventor has discovered that incorporation of polyamide 610 (nylon 6,10 or nylon 6/10) into an ionomer cover layer provides low spin rate and high launch angle when struck with a driver, with excellent speed off the tee. The golf ball thus exhibits the properties and characteristics that yield long drives. The ball also has high backspin rate when struck with an iron or a wedge, and thus exhibits desired properties and characteristics necessary for the golfer to exert control over the golf ball when approaching the green.

In particular, the inventor has discovered that the alloy of polyamide 610 and ionomer provides high hardness, as reflected in Shore D hardness values, that is difficult to achieve with an ionomer layer alone.

The inventor also has discovered that an alloy of ionomer and polyamide 610 provides a hard interior layer, such as an outer core layer, a mantle layer, or an inner cover layer. Such a hard interior layer can be advantageous as it may form a layer that is protection of interior layers it surrounds. An interior layer of the alloy also reduces use of petroleum resources.

Suitable ionomer compositions include the Surlyn® compounds available from El duPont de Nemours, lotek® ionomer compounds, available from ExxonMobil Corporation, and other ionomeric compounds. The identity and composition of the ionomeric compositions are not an important part of this disclosure.

Polyamide 610, also identified as PA610, is the reaction product of 1,6-diaminohexane and sebacoyl dichloride, as follows:

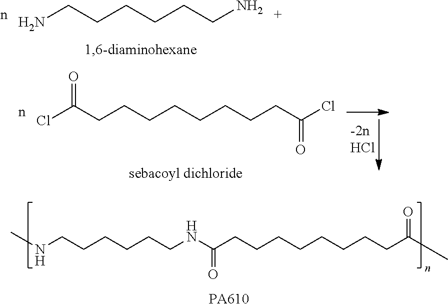

The reaction is carried out in any suitable manner, such as by interfacial condensation.

In embodiments of the disclosure, the PA610 is alloyed with ionomer resin, or blends thereof, to provide a composition for use as an outer cover layer of a golf ball. The composition provides higher hardness and higher launch angle of the golf ball when struck with a driver. The composition also is at least as durable the unalloyed ionomer cover layer. As can be seen from the structural formula, there exist in PA610 hydrogen atoms bonded to nitrogen atoms (amine hydrogens) and carbonyl oxygen atoms. Although the inventor does not wish to be bound by theory, the amine hydrogens and the carbonyl oxygens can hydrogen bond with each other and with the polar ionic groups on the ionomer molecules. Also, PA610 is at least partially crystalline. Thus, the ionomer/polyamide alloy material is a hard composition.

PA610 is better suited for this use than other nylon products. For example, PA610 exhibits better moisture resistance than does nylon 6 and nylon 6/12. PA610 is stronger than nylon 11, nylon 12, and nylon 6/12, and retains toughness at low temperatures better than nylon 6 or nylon 6/6.

Further, the source of sebacoyl dichloride is a renewable source. Sebacoyl dichloride is the dichloride of sebacic acid, which is derived from castor oil. Castor oil is obtained from the beans or seeds of the castor plant. Thus, not only is the sebacic acid naturally derived, but also is derived from a non-food source. As can be seen, at least about 50 percent of the polyamide component is from a renewable resource that does not affect food stocks, thus tending to make use of PA610 environmentally friendly and to reduce reliance on non-renewable resources.

Nylon 6,10 is commercially available from a number of sources. One source for PA610 is BASF, which sells PA610 under the trade name Ultramid® S3K Balance.

The ionomer/polyamide alloy is formed by blending the ionomer or ionomers with PA610, and then extruding the blend to form the alloy. The ionomer/polyamide alloy then can be molded to form a golf ball outer cover layer around a previously-formed ball having all other layers in place.

In embodiments of the disclosure, PA610 comprises between about 5 wt percent and about 50 wt percent of the ionomer/polyamide alloy, typically between about 10 wt percent and about 40 wt percent, and more typically between about 15 wt percent and about 35 wt percent. In embodiments of the disclosure, the PA610 comprises between about 20 wt percent and about 30 wt percent of the ionomer/polyamide alloy.

The Shore D surface hardness value of an outer cover layer comprising a polyamide 610/ionomer alloy disclosed herein is at least about 60, typically at least about 70, more typically at least about 72, and still more typically at least about 75.

The skilled practitioner recognizes that the cover also may include compositions, such as optical brightener, color, or density adjusting material, that do not affect the basic nature of the embodiments disclosed herein.

### Example

Golf balls were formed from a core having an ADC compression of 3.96 mm+/−0.03 mm. The components of the outer cover layer of Example 1 were formed into an ionomer/polyamide alloy; the ionomer and polyamide components are as set forth in Table 1. The outer cover layers of Comparative Examples (CE) 1-3 were ionomer blends, also set forth in Table 1. Characterizations of the outer cover layers of Comparative Examples 1-3 also are set forth in Table 1. All proportions are wt percent.

TABLE 1

| | | CE1 | CE2 (hard/ | CE3 |
|---|---|---|---|---|
| Component | Example 1 | (typical) | high acid) | (softer) |
| Surlyn ® 8940 | 40 | 50 | 40 | 40 |
| Surlyn ® 9910 | 40 | 50 | 40 | 40 |
| PA610 | 20 | | | |
| Surlyn ® 8150 | | | 20 | |
| Surlyn ® 9320 | | | | 20 |

The physical properties and characteristics of the golf balls identified in Table 1 and of golf balls commercially available from Nike under various trade names were determined. The properties and characteristics were determined as follows:

ADC compression was determined on a machine available from Applied Design Corporation. Compression deformation herein indicates the deformation amount of the ball, or any portion thereof, under a force; specifically, when the force is increased to become 130 kg from 10 kg, the deformation amount of the ball or portion thereof under the force of 130 kg reduced by the deformation amount of the ball or portion thereof under the force of 10 kg is the compression deformation value of the ball or portion thereof.

An ADC compression tester, commercially available from Automated Design Corp. in Illinois, USA, can be used to carry out this determination. The ADC compression tester can be set to apply a first load and obtain a first deformation amount, and then, after a selected period, apply a second, typically higher load and determine a second deformation amount. Thus, the first load herein is 10 kg, the second load herein is 130 kg, and the compression deformation is the difference between the second deformation and the first deformation. Herein, this distance is reported in millimeters. The compression can be reported as a distance, or as an equivalent to other deformation measurement techniques, such as Atti compression.

COR: A golf ball was fired by an air cannon at a steel plate positioned about 1.2 meters away from the air cannon at an initial velocity of 40 m/sec. A speed monitoring device was located over a distance of 0.6 to 0.9 meters from the cannon. After striking the plate, the golf ball rebounded through the speed-monitoring device. The return velocity divided by the initial velocity is the COR.

Surface hardness is determined on the Shore D scale.

Scuff was determined in accordance with a test designed to measure the scuff resistance of the cover of the golf ball based on a visual comparison of the appearance of the cover of the balls tested. Each sample ball is hit in 3 different spots by an aggressively grooved wedge using a golf lab robot (Nike Victory Red forged wedge, approximately 56 degrees (+/−2 degrees), with an initial ball speed of approximately 47-50 mph). The scuffing properties are evaluated by an evaluator who visually inspects the surface of the ball for damage and rates the sample or tested ball on a scuff scale.

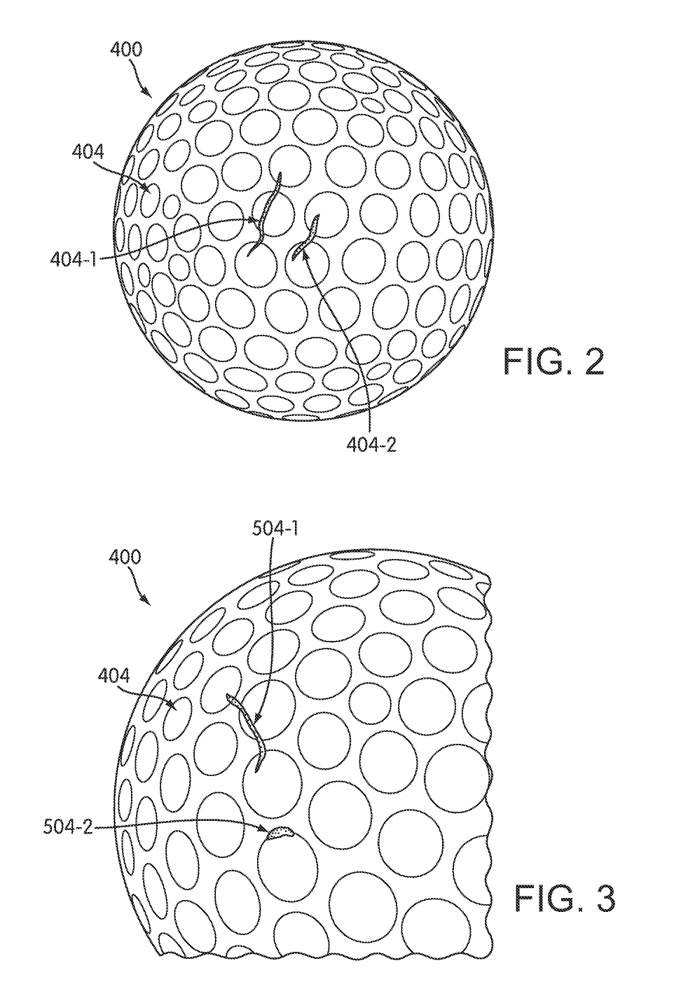

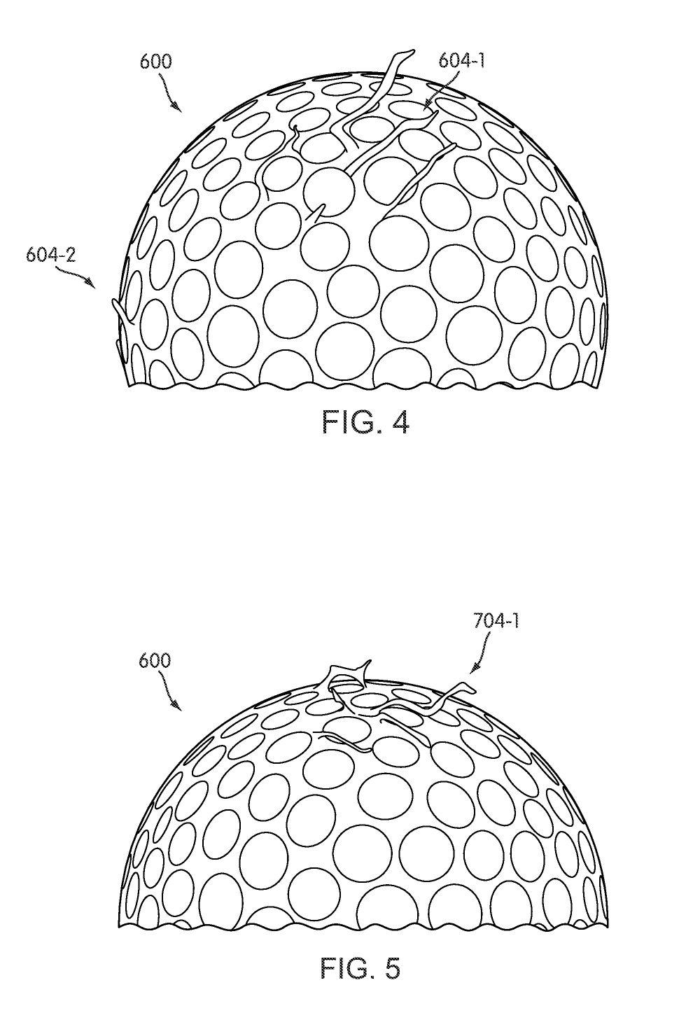

The scale may be any type of graded scale desired, with the gradations on the scale predetermined so that the evaluator can readily categorize the amount of damage to the cover of the ball. For the purposes of example only, a scale of 1-5 may be used, where a “1” scuff resistance score represents a ball having the highest scuff resistance, i.e., a ball which is not easily scuffed. See FIGS. 2 and 3, which illustrate golf ball 400 having cover 404 with minimal, if any deformation, at impact sites indicated as 404-1, 404-2, 504-1, and 504-2. A “5” scuff resistance score represents a ball having the lowest scuff resistance, i.e., a ball which is relatively easily scuffed. See FIGS. 4 and 5, which show a golf ball 600 from two different angles where there is a significant amount of abrasion and peeling at the impact sites indicated as 604-1, 604-2, and 704-1. A score of 2-4 are given to balls falling between these two extremes. A general description of the various scuff resistance levels used in this example test are provided in Table A.

TABLE A
Example Scuff Resistance Scale

| Scuff | |
|---|---|
| Resistance | |
| Score | Score Description |
| 1 | Minimal, if any, cover deformation. Impact site is |
| | difficult to see. Ridge lines from wedge face only |
| | noticeable alteration to cover. |
| 2 | Limited cover deformation/scuffing/material removal, |
| | some peeling of cover. |
| 3 | Some cover material scuffing, dimple pattern |
| | affected somewhat at impact site. Limited amount |
| | of cover material peeling off surface. |
| 4 | Noticeable deformation and abrasion of surface. |
| | Fair amount of cover peeling. Dimple pattern |
| | somewhat affected at impact site. |
| 5 | Substantial deformation and abrasion of impact |
| | site. Cover material peeling and/or missing |
| | altogether. Dimple pattern affected significantly. |

In addition to these descriptive terms, the evaluator may be provided with a sample photograph or sample ball with a ball having scuff marks previously evaluated or selected to be at a particular level.

In carrying out the test, the wedge abrasion conditions were loaded into the robot interface. The wedge then was mounted on the robot. Each sample golf ball was hit three times at three separation locations on each sample ball.

Each sample ball then was evaluated based on the 5 point scuff resistance scale shown in Table A. The results are summarized in Table 2 below. In other testing schemes, different scales may be used to delineate the differences between various levels of scuff resistance. Any scuff resistance scale will, however, in some way indicate which balls are generally easier to scuff, i.e., have low scuff resistance. Similarly, any scuff resistance scale will also in some way indicate which golf balls are generally more difficult to scuff, i.e., have high scuff resistance. In other testing regimes, however, multiple balls may be tested and simply compared to each other to determine which ball has higher scuff resistance than the other balls of the test, without using a scale or absolute categorization scheme.

Abrasion was measured by a test designed to test the durability of the outermost surface of a golf ball. The test conditions can be adjusted to test, for example, the durability of a coating or of an outer cover layer. The properties and characteristics of the sand and the run time can be adjusted to adjust the severity of the test.

In accordance with the test, ten balls and an equal mixture of sand and water occupying approximately 20% of the volume of a porcelain jar were tumbled in the jar of, for example an Amaco ball mill and evaluated. Typical operating conditions require about 8 hours operation with a sand selected with the expected durability of the outermost surface of the golf ball. One suitable type of sand is Fuji random A-36 or equivalent.

Equal volumes, about 2⅔ cups of water and 2⅔ cups of clean sand, were added to the porcelain jar. Ten balls were placed in the jar. If fewer than 10 balls were available for testing, jar balls were added as needed. The golf balls were tumbled for the pre-selected period, often 8 hours. Then, the golf balls were washed and dried for evaluation.

Each ball was evaluated on a scale of 1-5, best to worst. As is true for the scuff test, the evaluation is a relative one, based on a comparison of ball condition to a set of descriptions like that in Table B. Table B contains two comparison scales, one that relates to uncoated golf balls and one that relates to balls that are coated and printed with, for example, for example, logos and other markings. With the guidance provided herein, the skilled practitioner will be able to develop standards suitable for testing.

TABLE B
Abrasion Evaluation Scales

| Score | Uncoated ball | Coated ball |
|---|---|---|
| 1 | Little, if any, noticeable | Little, if any, noticeable degradation |
| Superior | degradation of ball surface. | of ball surface. Any markings or |
| abrasion | Any marks on ball remain | logos on ball remain unaffected. |
| resistance | unaffected. Premium balls | Premium balls usually perform at |
| | usually perform at this level. | this level. |
| 2 | Mark on ball are scuffed, but | Markings and logos on ball are |
| Moderate | majority of markings remain. | scuffed, but majority of markings |
| abrasion | Dimple shape unaffected. | remain. Dimple shape unaffected. |
| resistance | | Top coating can be seen in dimple |
| | | trough. |
| 3 | Most, if not all, of dimple ridge | Most, if not all, paint on dimple ridge |
| Average | shows wear. Marks might be | has been worn off. Logos and |
| abrasion | somewhat difficult to discern. | markings might be somewhat |
| resistance | Dimple ridges have been | difficult to read. Top coating |
| | slightly worn down. | remains in dimple trough, and |
| | | dimple ridges have been slightly |
| | | worn down. |
| 4 | Marks are very difficult to | Logos and markings are very |
| Limited | discern, as ridges and some | difficult to read, as paint has been |
| abrasion | parts of troughs are abraded. | extensively removed off ridges and |
| resistance | Dimple ridges are worn down | some parts of trough. Dimple ridges |
| | enough to reduce definition | are worn down enough to reduce |
| | and depth of dimple patterns. | definition and depth of dimple |
| | Limited areas of dimple | patterns. Limited top coating |
| | troughs remain unaffected. | remaining in dimple troughs. |
| 5 | Extensive cover damage, | Extensive cover damage, possible |
| Poor | possible degradation to the | degradation to the point where cover |
| abrasion | point where cover begins to | begins to disintegrate. Paint and |
| resistance | disintegrate. Surface is | logos are substantially worn down, |
| | substantially worn; perhaps | possibly no paint remaining on |
| | no area remains unaffected. | surface at all. Dimple definition |
| | Dimple definition reduced | reduced substantially due to cover |
| | substantially due to cover | being worn down. Limited top |
| | being worn down. | coating and luster remaining even in |
| | | dimple troughs. |

One-hundred Fifty-Shot Durability was determined by propelling a golf ball from a horizontal air cannon at a speed of 125 ft/sec (40 m/sec) to strike a vertical flat steel plate until the earlier of the failure of the golf ball or 150 shots. The numbers used to evaluate the results of this test are reported in the following style:

a/b (N1, N2, N3), wherein

a=number of golf balls that failed during the durability test;

b=number of golf balls used in the evaluation;

N1=number of cycles, or, how many times, a first ball was struck before failing;

N2=number of cycles, or, how many times, a second ball was struck before failing; and

N3=number of cycles, or, how many times, a third ball was struck before failing.

The information is summarized in Table 2, as follows:

TABLE 2

| | Ball | | | | | |
|---|---|---|---|---|---|---|
| | ADC Com- | | Shore | | Abra- | 150 Shot |
| | pression (mm) | COR | D | Scuff | sion | Durability |
| Example 1 | 2.91 | 0.8047 | 74.7 | 2.79 | 4 | 2/3 (126, |
| | | | | | | 142) |
| CE1 | 2.97 | 0.8060 | 73.3 | 2.42 | 3.75 | 3/3 (142, |
| | | | | | | 142, 143) |
| CE2 | 2.92 | 0.8083 | 74.3 | 2.92 | 4 | 0/3 |
| CE3 | 3.21 | 0.7921 | 70.5 | 2.71 | 3.9 | |
| PD Women | | | | | | |
| PD Long | | | 71.2 | 2.75 | 3.5 | |
| Mojo (Long) | | | 68.5 | 3.18 | 3.75 | |

The flight properties and characteristics of these balls were determined in accordance with standardized testing protocols and are summarized in Tables 3A-3C.

TABLE 3A
Driver strike at 140 mph

| Ball | Speed, mph | Launch angle, deg. | Backspin, rpm |
|---|---|---|---|
| Example 1 | 140.9 | 12.5 | 2165 |
| CE1 | 140.8 | 12.5 | 2090 |
| CE2 | 140.7 | 12.4 | 2171 |
| CE3 | 140.9 | 12.4 | 2293 |
| PD Women | 138.6 | 12.2 | 2228 |
| PD Long | 139.9 | 12.3 | 2244 |
| Mojo (Long) | 140.2 | 12.3 | 2145 |

TABLE 3B
7-Iron strike at 104 mph

| Ball | Speed, mph | Launch angle, deg. | Backspin, rpm |
|---|---|---|---|
| Example 1 | 105.2 | 20.8 | 7374 |
| CE1 | 104.0 | 21.2 | 7341 |
| CE2 | 103.9 | 21.7 | 7048 |
| CE3 | 103.7 | 21.2 | 7119 |
| PD Women | 103.3 | 21.4 | 7127 |
| PD Long | 104.0 | 21.1 | 7447 |
| Mojo (Long) | 103.6 | 20.3 | 7632 |

TABLE 3C
PW strike at 95 mph

| Ball | Speed, mph | Launch angle, deg. | Backspin, rpm |
|---|---|---|---|
| Example 1 | 94.0 | 26.1 | 8535 |
| CE1 | 94.0 | 26.3 | 8409 |
| CE2 | 94.1 | 26.3 | 8439 |
| CE3 | 93.3 | 26.4 | 8347 |
| PD Women | 93.3 | 26.0 | 8582 |
| PD Long | 94.4 | 26.4 | 8394 |
| Mojo (Long) | 92.9 | 26.2 | 8494 |

As can be seen from this information, the golf ball of embodiments of the disclosure, as illustrated by the golf ball of Example 1, has good durability and the highest hardness (Shore D), the highest driver-strike launch angle, and the highest 7-Iron strike speed of the golf balls tested, and exhibits other favorable properties and characteristics.

The golf ball of embodiments of the disclosure, as illustrated by the golf ball of Example 1, is more durable than comparable durable balls, as illustrated by the golf ball of Example CE1. Example CE1 illustrates a ball otherwise identical to the golf ball of Example 1, except that the outer cover layer of CE1 comprises only the Surlyn® components in the same ratio present in Example 1. The golf ball of Example 1 also is a high-performance golf ball, because it yields higher (driver and 7-iron) or equal (PW) departure speed than the high-performance golf ball of CE1. The golf ball of Example 1 also illustrates backspin speeds for each club strike superior to those of the golf ball of CE1.

Further, the golf ball embodiments of the disclosure are environmentally friendly compared with golf balls that contain no PA610 but are otherwise identical, because PA610 comprises a significant portion of renewable resources.

While various embodiments of the disclosure have been described, the description is intended to be exemplary, rather than limiting and it will be apparent to those of ordinary skill in the art that many more embodiments and implementations are possible that are within the scope of the disclosure. Accordingly, the disclosure is not to be restricted except in light of the attached claims and their equivalents. Also, various modifications and changes may be made within the scope of the attached claims. For example, different core materials may be used, and different numbers of layers may be present in the golf ball.

What is claimed is:

1. A high performance, environmentally friendly, durable golf ball having a layer comprising an alloy of ionomer and polyamide 610.

2. The golf ball of claim 1, wherein the layer comprising the alloy is an interior layer.

3. The golf ball of claim 2, wherein the layer comprising the alloy is a mantle layer.

4. The golf ball of claim 2, wherein the layer comprising the alloy is an outer core layer.

5. The golf ball of claim 1, wherein the layer comprising the alloy is a cover layer.

6. The golf ball of claim 5, wherein the layer comprising the alloy is an outer cover layer.

7. The golf ball of claim 1, wherein the alloy comprises between about 5 wt percent and about 50 wt percent polyamide 610, based on the weight of the alloy.

8. The golf ball of claim 7, wherein the alloy comprises between about 10 wt percent and about 40 wt percent polyamide 610, based on the weight of the alloy.

9. The golf ball of claim 8, wherein the alloy comprises between about 20 wt percent and about 30 wt percent polyamide 610, based on the weight of the alloy.

10. The golf ball of claim 1 wherein the alloy comprises a blend of ionomers.

11. The golf ball of claim 5, wherein the Shore D surface hardness value of the outer cover layer is at least about 70.

12. The golf ball of claim 6, wherein the Shore D surface hardness value of the outer cover layer is at least about 70.

13. The golf ball of claim 11, wherein the Shore D surface hardness value of the outer cover layer is at least about 72.

14. The golf ball of claim 12, wherein the Shore D surface hardness value of the outer cover layer is at least about 72.

15. A method for making an ionomer-containing high performance, durable golf ball having an inner layer and a cover layer environmentally friendly, the method comprising substituting an alloy of ionomer and polyamide 610 in place of ionomer in any layer of the golf ball.

16. The method of claim 15, wherein the substitution takes place in an inner layer.

17. The method of claim 16, wherein the substitution takes place in a cover layer.

18. The method of claim 17, wherein the substitution takes place in the outer cover layer.

19. The method of claim 17, wherein the alloy comprises between about 5 wt percent and about 50 wt percent polyamide 610, based on the weight of the alloy.

20. The golf ball of claim 19, wherein the alloy comprises between about 10 wt percent and about 40 wt percent polyamide 610, based on the weight of the alloy.
